(19) United States
(12) Patent Application Publication
(10) Pub. No.: US 2002/0077845 A1
(43) Pub. Date: Jun. 20, 2002

(54) Methods and apparatus for promoting oral hygiene

(75) Inventor: Anthony John Weir, Chester (GB)

Correspondence Address: UNILEVER, PATENT DEPARTMENT, 45 RIVER ROAD, EDGEWATER, NJ, 07020, US

(73) Assignee: Unilever Home & Personal Care USA Division of Conopco,Inc.

(21) Appl. No.: 10/002,271

(22) Filed: Nov. 15, 2001

(30) Foreign Application Priority Data
Dec. 15, 2000 (GB) 0027890.3

(51) Int. Cl. G06F 17/60

(52) U.S. Cl. 705/1

(57) ABSTRACT

An internet server is provided with a first database of oral hygiene usage information. A user can establish communication with the server, and enter characteristics of an individual (not necessarily the user himself), to extract from the first database information relevant to the individual. The server also maintains a second database of information accumulated concerning oral hygiene of a plurality of individuals. The server can collate this information, for example to generate information comparing the individuals or indicating that a message should be presented or transmitted to the individual.

### FIELD OF THE INVENTION

The present invention relates to methods and apparatus for promoting correct use of oral hygiene techniques and products.

### BACKGROUND OF THE INVENTION

Different individuals make different use of oral hygiene, depending on such characteristics as their ages and their geographical locations. For example, very young children should apply different amounts of toothpaste on their toothbrush to teenagers. Also, different countries or states have different regulatory provisions regarding the presence or concentration of ingredients permitted in toothpaste. Further, cultural factors heavily influence which types of paste may be preferred in different markets. For example in India there is a marketing preference for a toothpaste with anti-bacterial efficacy whereas in USA there is a preference for baking soda and peroxide toothpastes. Accordingly, different products are available with different packaging to suit each individual market.

In an alternative example certain markets comprise products which contain ingredients which are not at all available in another market. For example the natural products neem, jua and chrysanthemum/honeysuckle are available in toothpastes only in India, Brazil and China respectively.

While it is possible to provide correct instructions on paper, this is unreliable in the that some individuals may be supplied with information appropriate for another.

### SUMMARY OF THE INVENTION

The present invention aims to provide new and useful methods and apparatus for promoting optimal use of oral hygiene techniques and materials.

In general terms, a first aspect of the invention proposes that an internet server is provided with a database of oral hygiene usage information, and that, upon a user contacting the server, the server requests the user to input the characteristics of an individual (e.g. the user himself or herself), and accesses the database on the basis of this information to extract information appropriate to the individual.

As noted, the user of the server may be the individual himself. Alternatively he or she may be a different person responsible for the oral hygiene of the individual, such as a teacher, parent or dentist. In either case, the information may be input by making a selection from predetermined options stored by the server.

The database may contain, for example, the correct specification of oral hygiene products appropriate for individuals of any of a number of age ranges or geographical locations. It may further indicate likely preferences of such individuals (e.g. a user who is a teacher may be informed that in the USA like cinnamon, and those France like aniseed) and certain features of or references to a preferred product type may be incorporated in any brushing regime for any individual.

As a further example, a database may also contain data relevant to different age groups. For example, if the individual(s) is/are children then references to using products which are targeted to children may be preferred. Such products typically are low-foaming and only mildly flavoured. Other features which may be relevant to children include small doses of toothpaste: a child is recommended to use a mere pea-sized portion of toothpaste as opposed to the regular sized portion used when older. Children are also more susceptible to disorders of the tooth rather than the gum. Accordingly, any reference to caries will be preferred for a child. Currently, an adult or adolescent may prefer to be reminded of the dangers of gum disease rather than caries or sensitive teeth for a person living in a retirement home.

The information in the database may be more sophisticated, e.g. indicating a complete oral hygiene regime appropriate to the individual.

The server may further contain a database of links to further information resources (e.g. websites) relating to oral hygiene, such as a database of links to specific brand information sites or dental associations or the sites of suppliers of oral hygiene products. The user may be presented by the server with information from this database according to the characteristics of the individual (or indeed the user himself, if he is not the individual; in this case the interface may be adapted to receive the characteristics of the user). For example the location of the individual may influence the local dental association site or the supplier site to which the server directs the user. So might the age of the individual or the user, so that the site to which the user is directed may have an appropriate information complexity.

A second aspect of the invention proposes in general terms that the server maintains a database of information accumulated over a period of time from a number of individuals and concerning the individuals' oral hygiene usage, processes the data to derive characteristics of the individuals' oral hygiene, and communicates this information.

For example, the individuals may be children, who may enter information concerning their use of oral hygiene, possibly verified by an adult.

The processing of this accumulated data may be on the basis of a group of individuals, for example a class of children, to provide a comparison of the individuals. Alternatively, the processing may be to derive properties of a single individual's or class's usage, e.g. over a period of time of one or more days, one or more week or one or more months.

In either case, the results of the processing may be communicated on request, at predetermined time intervals or when the processing indicates that a criterion is met. The results may be communicated via an email message transmitted to the user's email address (or, if the user is not the individual, the individual's email address), or via a message in the form of a hypertext link to a certain webpage when the user connects to the site.

For example, in the case that the individual is a child, the server may generate a congratulatory message if the processing determines that a criterion of good oral hygiene use is met, or conversely an admonitory message in the case that the processing determines that a criterion of poor oral hygiene use is met, or even an encouraging message if between the two. A further possibility is that the message is a warning message transmitted by email in the case that the server has not received information from the user for a period of time, e.g. a predetermined period such as a week.

A combination of the two processing techniques may be employed, for example to provide a chart of data comparing a group of individuals (e.g. class of children) over a period of time. The chart may be downloadable from the server or communicated periodically, e.g. by email. A particular message or a reward (e.g. a gift voucher, a new toothbrush, etc) may be communicated to the individual in the group who has performed best according to a comparison criterion.

A particular advantage of some embodiments of the second aspect of the invention is that they can motivate children to make good use of oral hygiene techniques and materials.

Each of the first and second aspects of the invention may be expressed as a method or as a computer system arranged to perform the method.

The term “internet” is used here to particularly include the world wide web, however it is not limited in this respect and may further include other distributed electronic web network, such as a proprietary internet system, e.g. one owned by a health or educational organisation or operated by a company operating in the field of oral hygiene.

### BRIEF DESCRIPTION OF THE FIGURES

An embodiment of the invention will now be described for the sake of example only with reference to the following figures, in which:

FIG. 1 shows the overall operation of a system according to the invention;

FIG. 2 is a flow diagram of the steps in a first method according to the invention;

FIG. 3 is a flow diagram of the steps in a second method according to the invention;

FIG. 4 shows a record stored in one of the databases of the system of FIG. 1; and

FIG. 5 shows a window presented to the user during the method of FIG. 2.

### DETAILED DESCRIPTION OF THE EMBODIMENTS

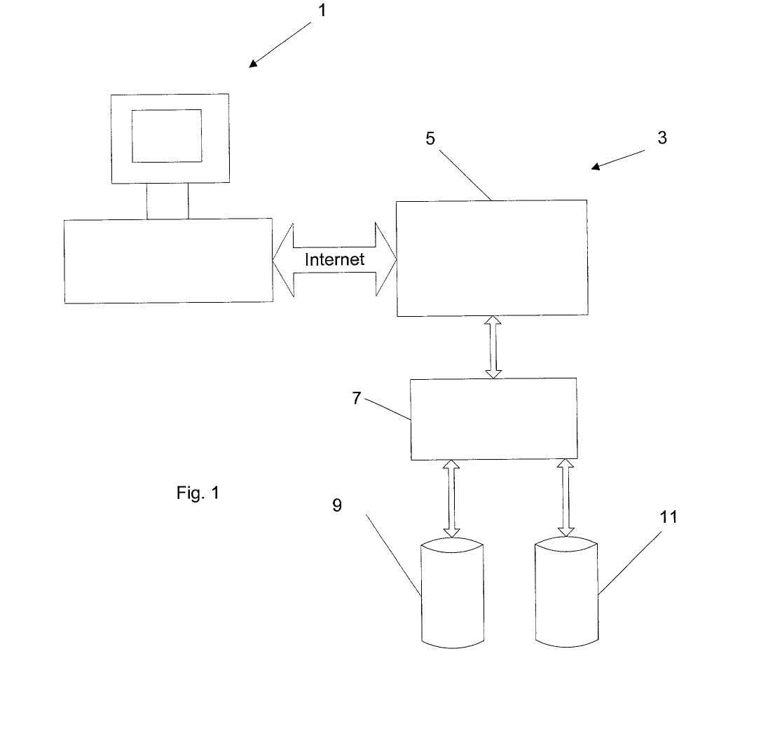

Referring firstly to FIG. 1, a first embodiment of the invention is shown in which a user, operating a terminal indicated generally as 1, communicates with a server system 3 by standard internet communication. For simplicity the user's ISP is not shown in the figure. The server system 3 comprises an interface unit 5 which operates an internet interface, a processor 7, and first and second databases 9, 11. The processor 7 can read data from the first database 9 and can both write data to and read data from the second database 11. The contents of the database 9 are predetermined by an operator of the server system 3 and entered into the database 9 using standard mechanisms (not illustrated in FIG. 1).

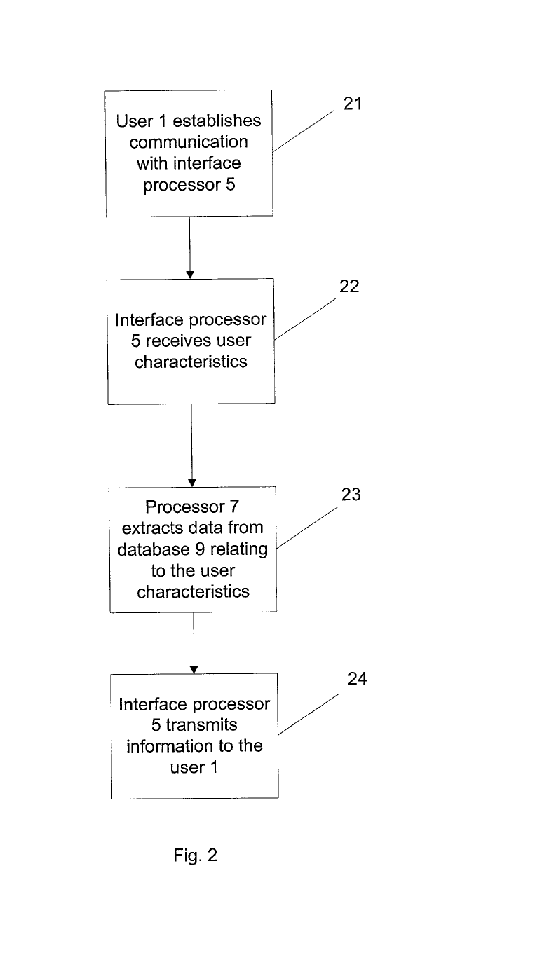

A first method performed by the system of FIG. 1 is illustrated in FIG. 2. In step 21 the user 1 establishes internet communication with the interface unit 5 of the server system 3. The interface presents the user with a window shown in FIG. 5, containing prompts 14, 16 instructing the user to enter his age and country of residence respectively into the boxes 15, 17. When he has finished the user clicks an “enter” button 18, and in step 22 the information the user has entered is transmitted to the interface unit 5. In step 23 the processor 7 uses the information derived in step 22 as the basis for a search in the database 9, and extracts the relevant data found. The data is presented to the user in step 24. The information may for example be information relating to a brand of oral healthcare product (e.g. a brand of toothpaste), flavourings, and/or usage instructions. It may further be data defining a link to a further site appropriate to the entered user characteristics.

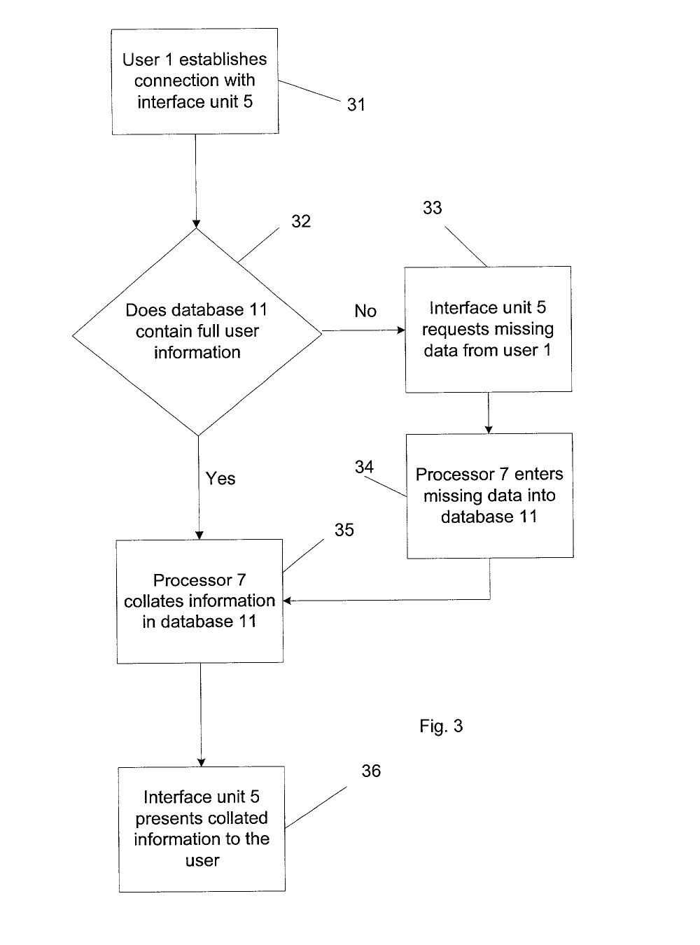

FIG. 3 shows the steps of a method which is a further embodiment of the invention, in which the user 1 connects to the interface unit 5 of the server system 3 in step 31. At this stage the user 1 identifies himself to the system, for example by entering a code number or based on a cookie.

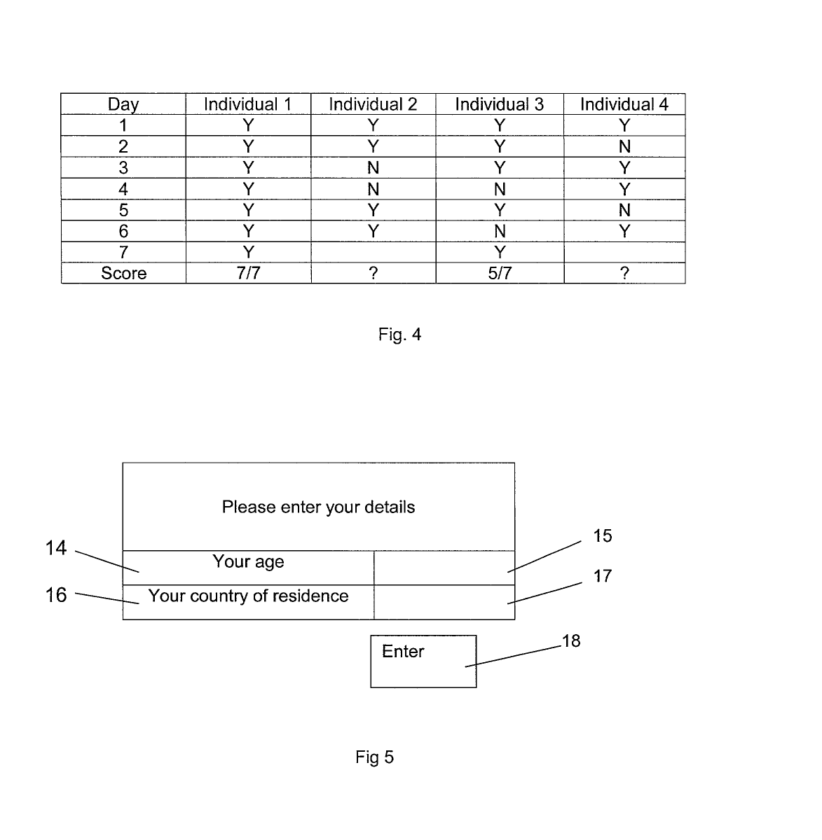

This method makes use of the second database 11, which generally contains a large number of data structures, each relating to a single individual, or a group of individuals. Such a data structure is shown in FIG. 4, and contains data relating to a group of 4 individuals (labelled “individual 1”, “individual 2”, “individual 3”, and “individual 4”), each associated with a column of the structure in FIG. 4. The individuals may for example be the members of a class. For each of the individuals, the data structure shown in FIG. 4 contains data indicating usage of oral hygiene by each of the individuals during a seven day period, each day corresponding to a row of the structure. A “Y” indicates the presence in the data structure of an element indicating that on a given day a given individual has taken a particular oral hygiene step (e.g. brushed his/her teeth using a certain product). Conversely, a “N” indicates that the individual has not. A blank in the table indicates that the database does not contain information for the corresponding individual for the corresponding day. The final line of each column gives a “score”, that is the number of days (out of seven) for which the hygiene step has been taken by that user. No score is given for individuals 2 and 4, since data giving their usage is missing from the table.

Consider the case of a user 1 who is responsible for the oral hygiene of the individuals (e.g. a teacher or parent in the case that the individuals are children). Such a user 1 may have been responsible for generating the data structure of FIG. 4 by sending appropriate instructions to the server system 3, e.g. via the interface unit 5. Upon the user 1 connecting to the server system in step 31, the system identifies the corresponding data structure.

In step 32 the processor 7 determines whether the data structure of FIG. 4 contains missing data for day 7. Thus, in step 32 it is identified that data is missing concerning the activities of individuals 2 and 4 on day 2, so the result of the determination of whether such data is missing is “yes”. The system then moves to stage 33, in which, via the interface unit 5, the user 1 is prompted to enter data for individuals 1 and 2. In step 34 this data is added to the database 11. If no data had been missing, then the result of the determination in step 32 would have been “no”.

In either case, the system then moves to step 35, in which the processor 7 collates the information in each of the columns of the structure of FIG. 4 to give a score for each individual. The user with the highest score is identified, and may be given a prize.

Note that it is possible for any of the four individuals to act as the “user”, and thus to communicate with the server system 3 to enter data only about himself (or herself), and to receive the “score” only for himself. In this case, the method operated by the server system is still as shown in FIG. 3, but the identification in step 31, the determination in step 32 and the collation in step 35 relate only to that individual.

Furthermore, it is possible within the scope of the invention for server system periodically to collate the information in the database 11 and to perform a notification action if the result of the collation falls into one of a number of cases, such as the case that for a given individual an excessive amount of information is missing and/or that the data which is present for that individual indicates that the oral hygiene usage of that individual may be inadequate. The notification action may for example be to generate an email message to the individual and/or to a person responsible for the oral hygiene of the individual.

Although particular embodiments of the invention have been described here, the invention is not limited in this respect but only by the scope of the appended claims. Many variants of the system described above will occur to a skilled reader. Some such variations have the advantage of increasing the interest to individuals in connecting to the server system 1.

For example, the server system 3 may be able to recognise a code (e.g. “crimp code”) which is present on an oral hygiene product obtained by an individual (who may be the “user” discussed above), by comparing that code against a list of such codes present in a further database (not shown). The code could for example be unique to each product item (i.e. different for each product item), or at least unique to each product item of a given type.

If the code entered by a certain individual corresponds to an code which has been specially pre-designated, the individual may be entitled to a prize. The individual may only be informed whether or not he has won the prize after he has completed the various steps desired by the operator of the server system 3, such as the completion of the data relating to that individual in the database 11.

Alternatively or additionally, the code may constitute a reference for a given individual, so that whenever that individual connects to the server system 3 that individual is re-identified following re-entry of the unique code. This code number may for example become associated with at least part of at least one data structure in the second database 11, e.g. a data structure which contains information about that individual.

1. A computer system for promoting oral hygiene, the system comprising a server arranged for internet communication with users, the server including:
an interface unit arranged to define an internet interface by which a user can input oral hygiene usage data relating to an individual;
a database for the usage data;
a processor for processing the usage data and communicating the results.

2. A computer system according to claim 1 in which the processor is arranged to process the usage data and make a comparison between the usage of a group of individuals.

3. A computer system according to claim 1 in which the processor is arranged to determine whether the usage data indicates acceptable or poor oral hygiene.

4. A computer system for promoting oral hygiene, the system comprising a server arranged for internet communication with users, the server including:
an interface unit arranged to define an internet interface by which a user can input characteristics of an individual;
a first database for storing oral hygiene instructions; and
a processor for extracting from the first database oral hygiene instructions according to characteristics input via the interface unit.

5. A computer system according to claim 4 in which the characteristics include the geographical location of the individual.

6. A computer system according to claim 4 in which the characteristics include the age of the individual.

7. A computer system according to claim 4 in which the server further includes a second database containing internet locations of further oral hygiene information resources, the server accessing the second database according to said characteristics.

8. A computer system according to claim 4 in which the server further includes a write-able database, the server being arranged to write information received from the user into the write-able database, to process it and to communicate the results.

9. A method for promoting oral hygiene, the method comprising:
maintaining a database for storing oral hygiene instructions;
defining an internet interface by which a user can input characteristics of an individual; and
extracting from the database oral hygiene instructions according to the input characteristics.

10. A method for promoting oral hygiene, the method comprising:
defining an internet interface by which a user can input oral hygiene usage data relating to an individual;
writing the usage data to a database; and
processing usage data accumulated in the database;
and communicating the results.
